(19) United States
(12) Patent Application Publication
(10) Pub. No.: US 2023/0398752 A1
(43) Pub. Date: Dec. 14, 2023

(54) CURING THERMOSET MATERIAL USING ELECTRIC HEATER(S) FOR THERMAL ANTI-ICING SYSTEM

(71) Applicant: Rohr, Inc., Chula Vista, CA (US)

(72) Inventor: Jennifer Davis, Carlsbad, CA (US)

(21) Appl. No.: 18/208,559

(22) Filed: Jun. 12, 2023

Related U.S. Application Data
(60) Provisional application No. 63/351,127, filed on Jun. 10, 2022.

(51) Int. Cl. B29C 70/68; B29C 70/44; B29C 70/70; B29C 35/02; B29C 73/10; B29C 73/26

(52) U.S. Cl. CPC B29C 70/682; B29C 70/44; B29C 70/70; B29C 35/0272; B29C 73/10; B29C 73/26; B29L 2031/3085

(57) ABSTRACT

A method is provided during which a composite preform is provided that includes an electric heater, fiber-reinforcement and thermoset material. The composite preform is consolidated to provide a composite aircraft component. The consolidating includes heating the thermoset material using the electric heater to cure the thermoset material. The electric heater and the fiber-reinforcement are embedded within the cured thermoset material. The electric heater is configured as a part of a thermal anti-icing system for melting and/or preventing ice accumulation on an exterior surface of the composite aircraft component.

This application claims priority to U.S. Patent Appln. No. 63/351,127 filed Jun. 10, 2022, which is hereby incorporated herein by reference in its entirety.

### BACKGROUND

### 1. Technical Field

This disclosure relates generally to an aircraft and, more particularly, to forming a composite component for the aircraft.

### 2. Background Information

An aircraft may include various thermoset composite components. Various methods are known in the art for forming such composite aircraft components. While these known formation methods have various advantages, there is still room in the art for improvement. There is a need in the art, for example, for methods for forming thermoset composite aircraft components using simpler, less expensive consolidation setups.

### SUMMARY OF THE DISCLOSURE

According to an aspect of the present disclosure, a method is provided during which a composite preform is provided that includes an electric heater, fiber-reinforcement and thermoset material. The composite preform is consolidated to provide a composite aircraft component. The consolidating includes heating the thermoset material using the electric heater to cure the thermoset material. The electric heater and the fiber-reinforcement are embedded within the cured thermoset material. The electric heater is configured as a part of a thermal anti-icing system for melting and/or preventing ice accumulation on an exterior surface of the composite aircraft component.

According to another aspect of the present disclosure, another method is provided during which a first member of a composite aircraft component and a second member of the composite aircraft component are arranged together. The first member includes an electric heater, first fiber-reinforcement and cured first thermoset material. The electric heater and the first fiber-reinforcement are embedded within the cured first thermoset material. The electric heater is configured as a part of a thermal anti-icing system for melting and/or preventing ice accumulation on an exterior surface of the composite aircraft component. The second member is heated using the electric heater to bond the second member to the first member.

According to still another aspect of the present disclosure, another method is provided during which a first member of a composite aircraft component is provided. The first member includes cured first thermoset material and first fiber-reinforcement embedded within the cured first thermoset material. A second member of the composite aircraft component is provided. The second member is disposed with the first member. The second member is heated using an electric heater to bond the second member to the first member. The electric heater is configured as a part of a thermal anti-icing system for melting and/or preventing ice accumulation on an exterior surface of the composite aircraft component.

The method may also include removing material from a damaged composite aircraft component to provide the first member. The second member may be configured as a patch to replace the removed material. The composite aircraft component may be a repaired composite aircraft component.

The second member may include second fiber-reinforcement and second thermoset material. The heating of the second member may include heating the second thermoset material using the electric heater to cure the second thermoset material and bond the second member to the first member. The second fiber-reinforcement may be embedded within the cured second thermoset material.

The second member may be configured from or otherwise include thermoplastic material. The heating of the second member may include melting the thermoplastic material.

The second member may include a second electric heater. The second member may also be heated using the second electric heater to bond the second member to the first member. The second electric heater may be configured as a part of the thermal anti-icing system for melting and/or preventing ice accumulation on the exterior surface of the composite aircraft component.

The consolidating may also include applying pressure to the composite preform using tooling.

The consolidating may also include applying pressure to the composite preform using a vacuum bag.

The providing of the composite preform may include laying up the electric heater between a first layer and a second layer. The first layer may include a first portion of the fiber-reinforcement and a first portion of the thermoset material. The second layer may include a second portion of the fiber-reinforcement and a second portion of the thermoset material.

The electric heater may include a plurality of electric heating elements embedded within the cured thermoset material.

The electric heating elements may be arranged in a grid.

The electric heater may be configured as or otherwise include a carbon nanotube heater embedded within the cured thermoset material.

The composite preform may also include a second electric heater. The second electric heater may be embedded within the cured thermoset material. The second electric heater may be configured as a second part of the thermal anti-icing system for melting and/or preventing ice accumulation on the exterior surface of the composite aircraft component.

The electric heater may heat up to a first temperature during the heating of the thermoset material. The second electric heater may heat up to a second temperature during the heating of the thermoset material that is different than the first temperature.

The electric heater and the second electric heater may heat up to a common temperature during the heating of the thermoset material.

The method may also include monitoring the consolidation of the composite preform using a sensor. The composite preform may also include the sensor. The sensor may be embedded within the cured thermoset material.

A nacelle inlet structure may include the composite aircraft component. The electric heater may be located at a leading edge of the nacelle inlet structure.

An aircraft wing may include the composite aircraft component. The electric heater may be located at a leading edge of the aircraft wing.

An aircraft stabilizer may include the composite aircraft component. The electric heater may be located at a leading edge of the aircraft stabilizer.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic illustration of an assembly for an aircraft with a composite aircraft component and a thermal anti-icing system.

FIG. 2 is a perspective illustration of the aircraft.

FIGS. 3A-C are partial schematic sectional illustrations of the aircraft component with various different layer configurations.

FIGS. 4A and 4B are partial schematic illustrations of an electric heater with various heating element arrangements.

FIG. 5 is a flow diagram of a method for forming the aircraft component.

FIGS. 6A-C are partial schematic sectional illustrations of a composite preform arranged with tooling.

FIG. 7 is a schematic illustration of the composite preform pressed between the tooling and a vacuum bag during consolidation.

FIG. 8 is a schematic illustration of the aircraft component/the composite preform with multiple electric heaters.

FIG. 9 is a schematic illustration of the aircraft component/the composite preform with one or more internal sensors.

FIGS. 10A-C are schematic illustrations depicting repair of the aircraft component.

### DETAILED DESCRIPTION

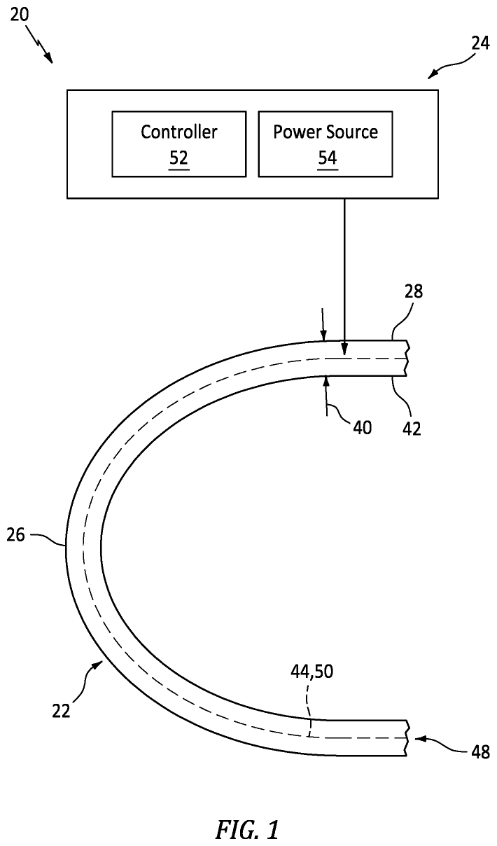

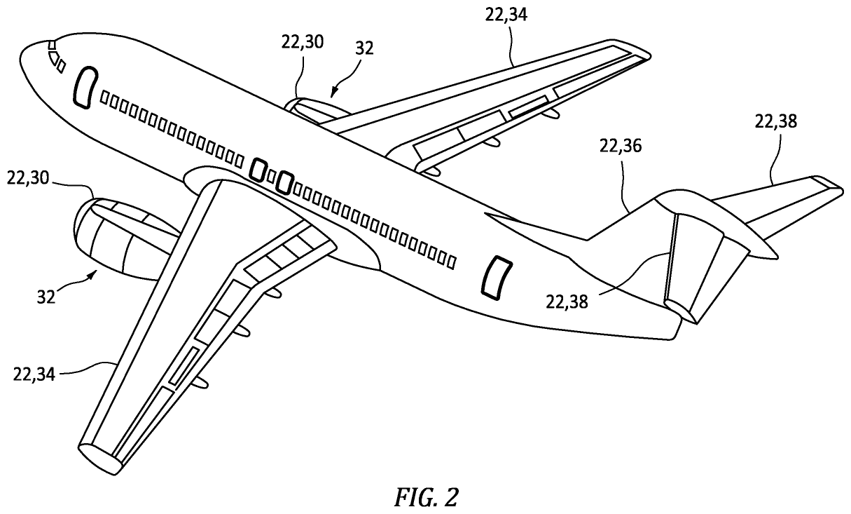

FIG. 1 illustrates an assembly 20 for an aircraft. The aircraft may be configured as an airplane, a helicopter, a drone (e.g., an unmanned aerial vehicle (UAV)), a spacecraft or any other manned or unmanned aerial vehicle. However, for ease of description, the aircraft is described below and illustrated in FIG. 2 as the airplane. The aircraft assembly 20 of FIG. 1 includes a composite aircraft component 22 and a thermal anti-icing system 24.

The aircraft component 22 may be configured as any component of the aircraft with a leading edge 26 and/or at least one aerodynamic exterior surface 28. For example, referring to FIG. 2, the aircraft component 22 may be configured as or included as part of an inlet structure 30 of nacelle for an aircraft propulsion system 32; e.g., an inlet structure noselip. The aircraft component 22 may alternatively be configured as or included as part of an airfoil such as, but not limited to, a wing 34 for the aircraft, a vertical stabilizer 36 for the aircraft, or a horizontal stabilizer 38 for the aircraft. Another example of the airfoil is an inlet guide vane for the aircraft propulsion system. The aircraft component 22, however, is not limited to the foregoing exemplary component configurations.

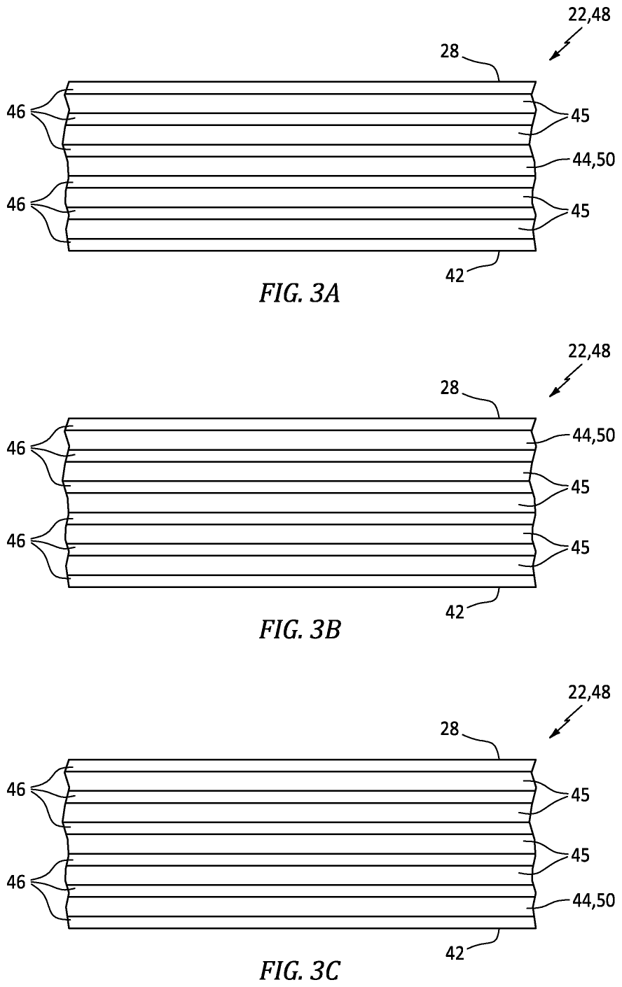

The aircraft component 22 of FIG. 1 extends longitudinally (e.g., axially along an axial centerline and/or lengthwise along an airfoil camber line) to the component leading edge 26. The aircraft component 22 has a thickness 40 that extends laterally between and to an interior surface 42 of the aircraft component 22 and the component exterior surface 28. The aircraft component 22 of FIGS. 3A-C includes at least one electric heater 44, fiber-reinforcement and cured thermoset material 46. The electric heater 44 and the fiber-reinforcement 45 are embedded within the cured thermoset material 46, where the component elements 44-46 collectively form a body 48 (e.g., a skin, a wall, etc.) of the aircraft component 22.

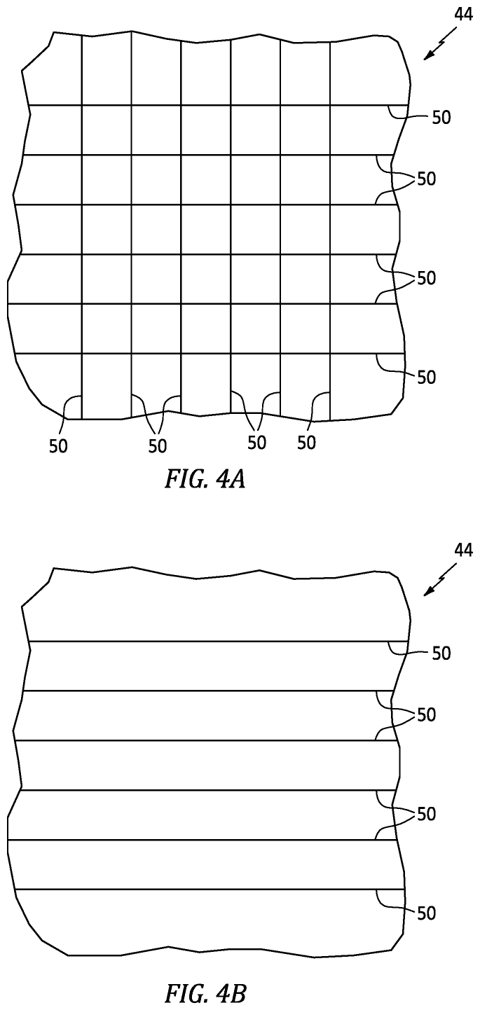

Referring to FIGS. 4A and 4B, the electric heater 44 includes one or more electric heating elements 50 arranged in a grid (e.g., see FIG. 4A), an array (e.g., see FIG. 4B) or any other arrangement. The heating elements 50 may be electrically interconnected to provide a single heating zone across/along the aircraft component 22 and its elements 26 and 28 (see FIG. 1). Alternatively, the heating elements 50 may be configured to provide multiple discrete heating zones across/along the aircraft component 22 and its elements 26 and 28 (see FIG. 1). Each of the heating elements 50 may be configured as an electric carbon nanotube heater. One or more or all of the heating elements 50, however, may alternatively be configured as another type of electrically resistive heating element such as a resistive metal heating wire.

Referring to FIGS. 3A-C, the electric heater 44 and its heating elements 50 are thermally coupled with the component exterior surface 28 through at least the cured thermoset material 46. Referring to FIG. 3A, the electric heater 44 and its heating elements 50 may be arranged (e.g., sandwiched) laterally between multiple layers of the fiber-reinforcement 45. The electric heater 44 may thereby be disposed intermediately (e.g., midway) between the component interior surface 42 and the component exterior surface 28. Alternatively, referring to FIG. 3B, the electric heater 44 and its heating elements 50 may be arranged adjacent (or otherwise at) the component exterior surface 28. Still alternatively, referring to FIG. 3C, the electric heater 44 and its heating elements 50 may be arranged adjacent (or otherwise at) the component interior surface 42. The heating elements 50, of course, may also be located at multiple different lateral locations within the component body 48 between the component interior surface 42 and the component exterior surface 28 to provide a multi-layer heater arrangement.

The fiber-reinforcement 45 may be arranged into the one or more reinforcement layers. Each layer of the fiber-reinforcement 45 includes one or more long strand, short strand and/or chopped fibers. Prior to consolidation of the aircraft component 22, the fibers in each reinforcement layer may be woven into a weave or otherwise arranged together to provide a fiber-reinforcement cloth or mat. Examples of the fiber-reinforcement 45 include, but are not limited to, fiberglass material, carbon fiber material and aramid (e.g., Kevlar®) material.

The cured thermoset material 46 provides a thermoset matrix into which the electric heater 44 and the fiber-reinforcement 45 are disposed; e.g., embedded, encapsulated, etc.

Referring to FIG. 1, the thermal anti-icing system 24 includes the at least one electric heater 44 that is part of and/or embedded within the aircraft component 22. The thermal anti-icing system 24 also include a controller 52 and an electrical power source 54; e.g., one or more batteries, a generator, etc. This thermal anti-icing system 24 is configured to melt and/or prevent ice accumulation on the component exterior surface 28, for example, at (e.g., on, adjacent or proximate) and along the component leading edge 26. The controller 52, for example, may signal the power source 54 (or a switch and/or other regulator between the power source 54 and the electric heater 44) to provide electricity to the electric heater 44. The electricity energizers the electric heater 44 and its heating elements 50, and the electric heater 44 generates heat energy. Referring to FIGS. 3A-C, the heat energy transfers (e.g., conducts) through at least the cured thermoset material 46 towards (e.g., to) the component exterior surface 28 thereby heating the component exterior surface 28 to an elevated temperature. This elevated temperature may be selected to be warm enough to melt any ice accumulating on the component exterior surface 28 and/or prevent accumulation of the ice on the component exterior surface 28, while cool enough so as not to damage the aircraft component 22 or any surrounding components and/or needlessly expend energy.

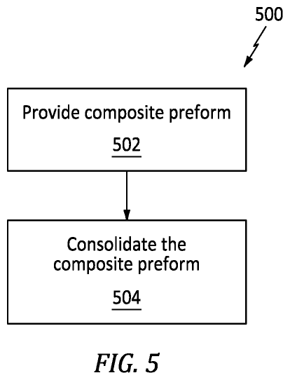

FIG. 5 is a flow diagram of a method 500 for forming a composite aircraft component with at least one internal electric heater. For ease of description, the method 500 is described below with respect to forming the aircraft component 22. The formation method 500 of the present disclosure, however, is not limited to such an exemplary aircraft component.

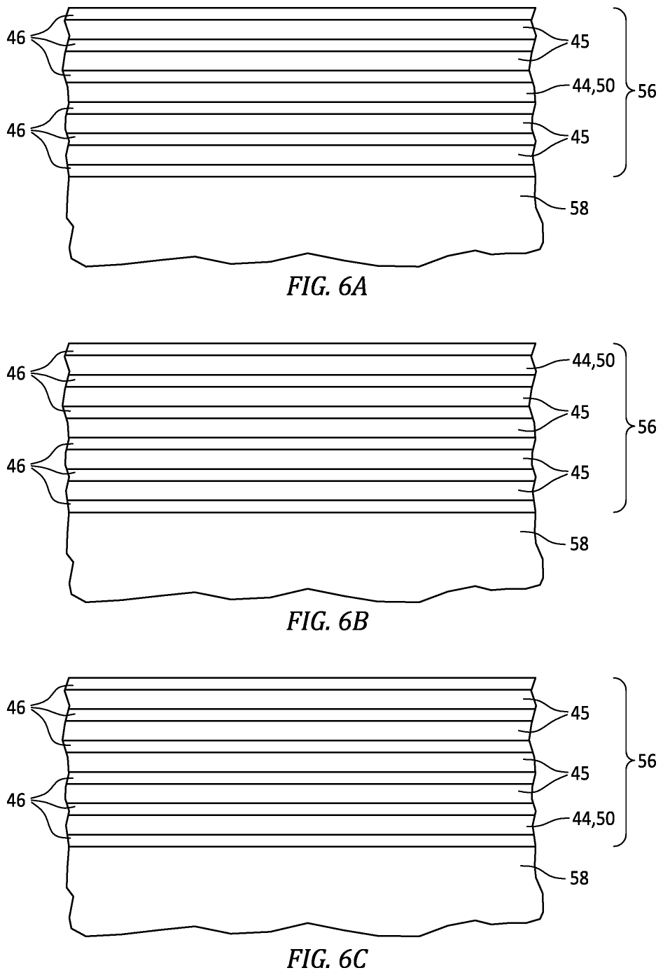

In step 502, a composite preform 56 of the aircraft component 22 is provided. This composite preform 56 may generally have the same shape and dimensions as the aircraft component 22 being formed. Referring to FIGS. 6A-C, the composite preform 56 includes the at least one electric heater 44 and the fiber-reinforcement 45. The composite preform 56 may also include the thermoset material 46′ (in an uncured or partially cured state). The fiber-reinforcement 45 and at least some or all of the thermoset material 46′, for example, may be provided together as one or more layers (e.g., sheets) of prepreg. The term “prepreg” may describe herein a sheet of fiber-reinforcement that is pre-impregnated with uncured or partially cured thermoset material. To form the composite preform 56, the electric heater 44 may be laid up with the prepreg layers against tooling 58; e.g., a die or other form. The electric heater 44 of FIG. 6A is laid up between the prepreg layers. The electric heater 44 of FIGS. 6B and 6C is laid up to a respective side of the prepreg layers.

The thermoset material 46′ is described above as being included with the fiber-reinforcement 45 in the prepreg layers. Of course, various other techniques are known in the art for delivering thermoset material to a preform, and the present disclosure is not limited to any particular ones thereof.

In step 504, the composite preform 56 is consolidated to provide the aircraft component 22. During this consolidation, the composite preform 56 may be subjected to pressure and/or heat to bring together the preform elements 44-46′ and cure the thermoset material 46′.

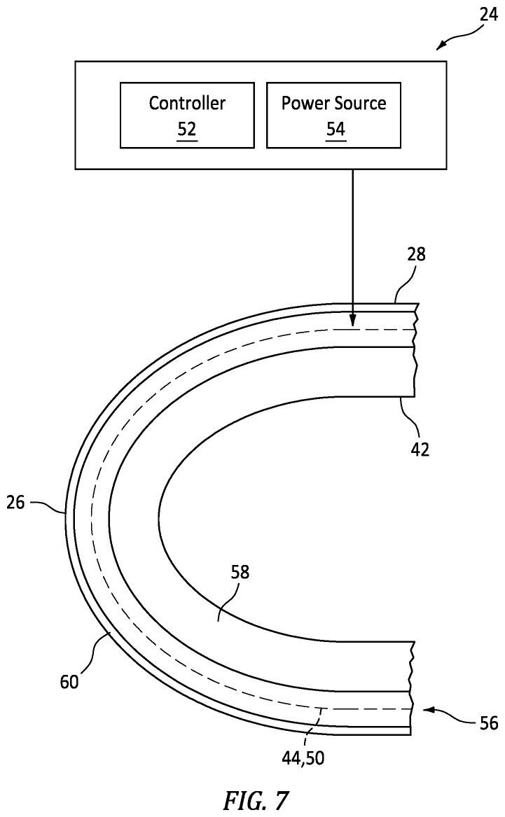

Referring to FIG. 7, pressure may be applied to the composite preform 56 using a vacuum bag 60 and the tooling 58. The composite preform 56 of FIG. 7, for example, is disposed between the vacuum bag 60 and the tooling 58 such that the vacuum bag 60 pushes the composite preform 56 against the tooling 58. Alternatively, the composite preform 56 may be pressed between opposing sets of tooling 58; e.g., an interior die and an exterior die. Of course, various other methods are known in the art for applying pressure to a preform, and the present disclosure is not limited to any particular ones thereof.

To heat the composite preform 56 and, more particularly, the uncured (or partially cured) thermoset material 46′, at least (or only) the electric heater 44 is energized; e.g., turned on. This electric heater 44 may be energized by the thermal anti-icing system elements 52 and 54 or other similar elements, for example, dedicated to component forming. The electric heater 44 and its heating elements 50 thereby produce heat energy and heat up the surrounding material including the thermoset material 46′. The heat produced by the electric heater 44 and its heating elements 50 during this consolidation step 504 may be enough (or more than enough) to elevate the thermoset material 46′ in the prepreg to or above its cure temperature. Of course, in other embodiments, additional heat may also be input from an external heating source (not shown); although, preferably such an external heating source is not required.

It should be noted, the heat energy generated by the electric heater 44 and its heating elements 50 during aircraft operation for thermal anti-icing may be (e.g., significantly) less than that during the consolidation step 504 so as to prevent thermal degradation of one or more other nearby aircraft components as well as prevent excess expenditure of energy. For example, during the consolidation, the electric heater 44 may be heated to a relatively high consolidation temperature whereas the electric heater 44 may be heated to a relatively low anti-icing temperature during aircraft operation. The consolidation temperature, of course, may vary depending upon the specific thermoset material 46, 46′ included in the aircraft component 22.

By using the integral electric heater 44 for the consolidation step 504, no additional heater(s) (e.g., outside of the composite preform 56) are needed for forming the aircraft component 22. This may significantly reduce an initial setup cost for producing the aircraft components 22. Furthermore, the electric heater 44 can heat the thermoset material 46′ with less interference (e.g., thermal resistance) than a heater external to the composite preform 56 and the tooling 58/the vacuum bag 60.

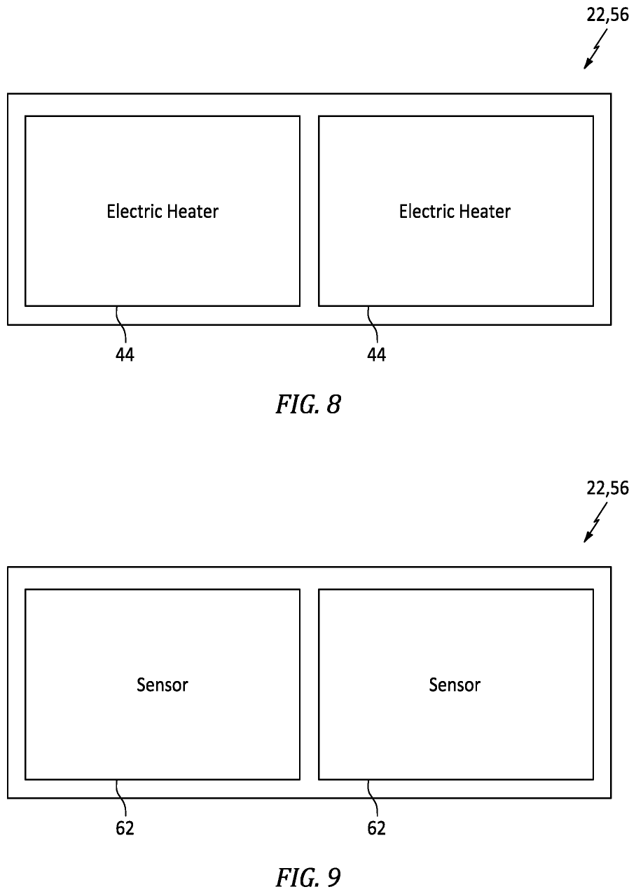

In some embodiments, referring to FIG. 8, the aircraft component 22 may include multiple of the internal electric heaters 44. These electric heaters 44 may be operated to heat the surrounding composite preform material to a common (e.g., the same) temperature during the consolidation step 504. Alternatively, the electric heaters 44 may be operated to heat the surrounding composite preform material to different temperatures during the consolidation step 504. The heating during the consolidation step 504 may thereby be tailored to dimensional differences, etc. in the composite preform 56.

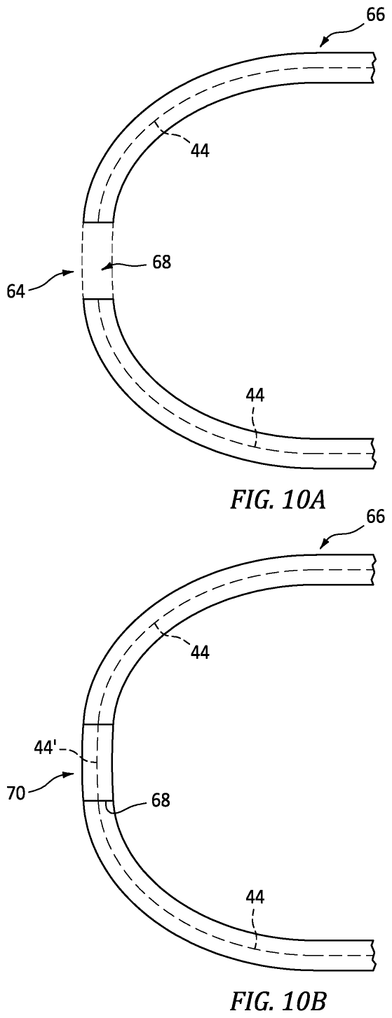

In some embodiments, referring to FIG. 9, the consolidation of the composite preform 56 may be monitored using a sensor system with one or more sensors 62. One or more or all of these sensors 62 may be arranged within the composite preform 56. The sensors 62 may thereby be embedded within the cured thermoset material 46 of the aircraft component 22. These sensors 62 may also or alternatively be used to monitor the thermal anti-icing, the aircraft component 22 and/or an environment surrounding the aircraft component 22 during aircraft operation. Examples of the sensors 62 include, but are not limited to, temperature sensors and pressure sensors.

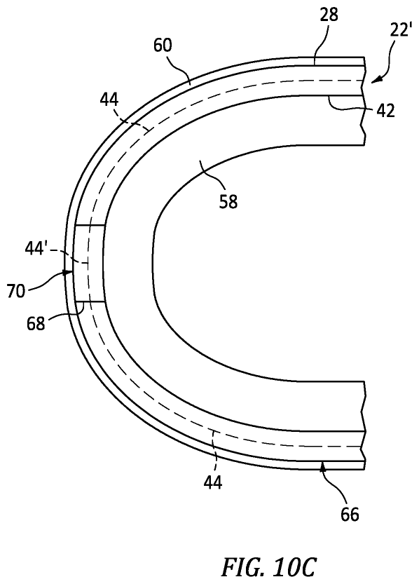

While the heater(s) 44 are described above for forming the aircraft component 22, the heater(s) 44 may also or alternatively be used for repairing the aircraft component 22. For example, referring to FIG. 10A, a damaged portion 64 of the aircraft component 22 may be removed to provide a base member 66 of a future repaired composite aircraft component 22′ (see FIG. 10C). This base member 66 includes a void 68 (e.g., a hole, a groove, a notch, a recession, a depression, etc.) at a location of where the damaged portion 64 was removed. Referring to FIG. 10B, a repair member 70 is arranged with the base member 66 to fill, cover and/or otherwise patch the void 68. This repair member 70 may have a similar configuration/makeup as the composite preform 56 described above. The repair member 70 of FIG. 10B, for example, includes fiber-reinforcement and uncured or partially cured thermoset material (e.g., similar to that shown in FIGS. 3A-C); e.g., one or more layers of prepreg. The repair member 70 of FIG. 10B also include at least one electric heater 44′ laid up with the prepreg layers (e.g., similar to that shown in FIGS. 3A-C). Referring to FIG. 10C, the repair member 70 may be pressed against the base member 66 using the tooling 58, the vacuum bag 60 and/or other techniques. The thermoset material in the repair member 70 may then be heated by the electric heater(s) 44 in the base member 66 and/or the electric heater 44′ in the repair member 70 to cure the thermoset material in the repair member 70 and bond the repair member 70 to the base member 66. The repair member 70 may thereby be consolidated with the base member 66 to form the repaired aircraft component 22′.

In some embodiments, the electric heater 44′ in the repair member 70 of the repaired aircraft component 22′ may be included as a part of the thermal anti-icing system 24 (see FIG. 1). Of course, in other embodiments, the repair member 70 may be configured without its own integral electric heater.

While the repair member 70 may include the thermoset material, the present disclosure is not limited thereto. For example, in other embodiments, the thermoset material in the repair member 70 may be replaced with thermoplastic material. With such an arrangement, one or more of the electric heaters 44, 44′ may be configured to melt the thermoplastic material for bonding to the base member 66.

The member 66 is described above as a part of a damaged aircraft component and the member 70 is described as a repair member for patching the void 68 in the damaged aircraft component. However, it is contemplated that multiple new (e.g., non-damaged) members 66 and may be joined together using the foregoing consolidation and bonding process to form a new (e.g., non-repaired) aircraft component.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A method, comprising:
providing a composite preform that includes an electric heater, fiber-reinforcement and thermoset material; and
consolidating the composite preform to provide a composite aircraft component, the consolidating comprising heating the thermoset material using the electric heater to cure the thermoset material, the electric heater and the fiber-reinforcement embedded within the cured thermoset material, and the electric heater configured as a part of a thermal anti-icing system for melting and/or preventing ice accumulation on an exterior surface of the composite aircraft component.

2. The method of claim 1, wherein the consolidating further comprises applying pressure to the composite preform using tooling.

3. The method of claim 1, wherein the consolidating further comprises applying pressure to the composite preform using a vacuum bag.

4. The method of claim 1, wherein
the providing of the composite preform comprises laying up the electric heater between a first layer and a second layer;
the first layer includes a first portion of the fiber-reinforcement and a first portion of the thermoset material; and
the second layer includes a second portion of the fiber-reinforcement and a second portion of the thermoset material.

5. The method of claim 1, wherein the electric heater comprises a plurality of electric heating elements embedded within the cured thermoset material.

6. The method of claim 5, wherein the electric heating elements are arranged in a grid.

7. The method of claim 1, wherein the electric heater comprises a carbon nanotube heater embedded within the cured thermoset material.

8. The method of claim 1, wherein
the composite preform further includes a second electric heater;
the second electric heater is embedded within the cured thermoset material; and
the second electric heater is configured as a second part of the thermal anti-icing system for melting and/or preventing ice accumulation on the exterior surface of the composite aircraft component.

9. The method of claim 8, wherein
the electric heater heats up to a first temperature during the heating of the thermoset material; and
the second electric heater heats up to a second temperature during the heating of the thermoset material that is different than the first temperature.

10. The method of claim 8, wherein the electric heater and the second electric heater heat up to a common temperature during the heating of the thermoset material.

11. The method of claim 1, further comprising:
monitoring the consolidation of the composite preform using a sensor;
the composite preform further including the sensor; and
the sensor embedded within the cured thermoset material.

12. The method of claim 1, wherein
a nacelle inlet structure comprises the composite aircraft component; and
the electric heater is located at a leading edge of the nacelle inlet structure.

13. The method of claim 1, wherein
an aircraft wing comprises the composite aircraft component; and
the electric heater is located at a leading edge of the aircraft wing.

14. The method of claim 1, wherein
an aircraft stabilizer comprises the composite aircraft component; and
the electric heater is located at a leading edge of the aircraft stabilizer.

15. A method, comprising:
arranging a first member of a composite aircraft component and a second member of the composite aircraft component together, the first member including an electric heater, first fiber-reinforcement and cured first thermoset material, the electric heater and the first fiber-reinforcement embedded within the cured first thermoset material, and the electric heater configured as a part of a thermal anti-icing system for melting and/or preventing ice accumulation on an exterior surface of the composite aircraft component; and
heating the second member using the electric heater to bond the second member to the first member.

16. The method of claim 15, further comprising removing material from a damaged composite aircraft component to provide the first member, wherein the second member is configured as a patch to replace the removed material, and the composite aircraft component is a repaired composite aircraft component.

17. The method of claim 15, wherein
the second member includes second fiber-reinforcement and second thermoset material;
the heating of the second member comprises heating the second thermoset material using the electric heater to cure the second thermoset material and bond the second member to the first member; and
the second fiber-reinforcement is embedded within the cured second thermoset material.

18. The method of claim 15, wherein
the second member comprises thermoplastic material; and
the heating of the second member comprises melting the thermoplastic material.

19. The method of claim 15, wherein
the second member comprises a second electric heater;
the second member is further heated using the second electric heater to bond the second member to the first member; and
the second electric heater is configured as a part of the thermal anti-icing system for melting and/or preventing ice accumulation on the exterior surface of the composite aircraft component.

20. A method, comprising:
providing a first member of a composite aircraft component, the first member including cured first thermoset material and first fiber-reinforcement embedded within the cured first thermoset material;
providing a second member of the composite aircraft component;
disposing the second member with the first member; and
heating the second member using an electric heater to bond the second member to the first member, the electric heater configured as a part of a thermal anti-icing system for melting and/or preventing ice accumulation on an exterior surface of the composite aircraft component.
